(19) United States
(12) Patent Application Publication
(10) Pub. No.: US 2005/0093183 A1
(43) Pub. Date: May 5, 2005

(54) Cooling tower with high surface area packing

(76) Inventors: Larry Lewis, Houston, TX (US); Ned P. Baudat, New Braunfels, TX (US); Jeffrey A. Diaz, Spring, TX (US)

Correspondence Address: Martin L. McGregor, Suite 201, 13231 Champion Forest Dr., Houston, TX, 77069, US

(21) Appl. No.: 10/700,799

(22) Filed: Nov. 3, 2003

(51) Int. Cl. B01F 3/04

(52) U.S. Cl. 261/94; 261/DIG. 11; 261/DIG. 72

(57) ABSTRACT

A method and apparatus is provided for cooling a water stream in an evaporative cooling tower that comprises passing the water stream thru a flow distribution means over a high surface area packing material to wet the surface of the packing material and contacting the wet packing material surface with a moving gas stream.

### TECHNICAL FIELD

This invention pertains to the field of cooling tower operation and specifically to the rejection of heat from a closed loop cooling tower to atmospheric air.

### BACKGROUND OF THE INVENTION

Cooling Towers have employed wooden plank fill, fiberglass plank fill, and structured packing for an evaporative media surface to allow water to be cooled by evaporation when exposed to ambient air. Various materials have been developed over the years for use in fractionating towers to remove contaminants from gases. Baudat, U.S. Pub. Patent App. No. 20010054354 teaches the use of evaporative cooling—utilizing a scrubber having a cooling media to cool the inlet air of a gas turbine for improved efficiency.

The art has not heretofore recognized the unexpected advantage of using a high surface area random fill packing to allow a closer approach to wet bulb temperature, while maintaining high velocities, small cross-sections, and low fan power requirements.

Applying the concepts of the current invention, the approach to wet bulb temperature in cooling towers can be reduced to a range of 0-2.9 deg F., which is currently limited to a practical range of 3-7 deg F. with conventional fill.

### SUMMARY OF THE INVENTION

The invention may be described in several ways as alternate embodiments of the same novel discovery.

A conventional cooling tower utilizes wood plank fill, fiberglass plank fill, structured packing, or other similar material to provide surface for the warm water returned from cooling duties to be sprayed over. The water is cooled by evaporation when a gas preferably ambient air is blown or drawn in contact with the packing material and the water or other liquid evaporates removing heat from its surroundings. This cooling is practically limited by contact time and surface area such that in prior art methods a 3-7 deg F. approach between the air wet bulb and the leaving water is generally used for design. By increasing the available surface area with high surface area fill packing, preferably a random packing, the contact time is dramatically increased and the approach temperature between air wet bulb and leaving water temperature can be reduced to 0-2.9 deg F. in the same area and with similar air pressure drop.

The invention provides a method for cooling a water stream in an evaporative cooling tower that comprises: passing the water stream thru a flow distribution means over a high surface area packing material to wet the surface of the random packing material and contacting the wet packing material surface with a moving air stream. A preferred method includes the step of utilizing a high surface area packing having the properties of high surface area while also offering low air pressure drop resistance. A preferred method uses a high surface area packing is selected from the group consisting of spherical, snowflake, or pall ring. The method may include the step of using a high surface area packing constructed from a material selected from the group consisting of glass, ceramic, metal, plastic, or glass impregnated plastic. In a preferred method the high surface packing is constructed from a plastic material selected from the group consisting of, polyethylene, polypropylene, or perfluoropolyethylene. Another preferred method includes the step of utilizing a high surface area packing having the properties of high surface area allowing the packed bed depth to be reduced, thereby allowing the distribution system height to be lowered, thus reducing the circulating water pumping head and horsepower. A preferred method employs a high surface area random packing having a surface area in the range of 400 square meters/cubic meter to 3000 square meters/cubic meter. An especially preferred method uses a high surface area packing having a surface area in the range of 400 square meters/cubic meter to 1500 square meters/cubic meter.

The invention also provides an apparatus for cooling a water stream comprising an evaporative cooling tower that comprises a pumping means for delivering a cooling water stream thru a flow distribution means to deliver water flow over a high surface area packing material such that the flowing water wets the surface of the high surface area packing material and means for contacting the wet packing material surface with a moving air stream. A preferred apparatus includes a high surface area packing having the properties of high surface area while also offering low air pressure drop resistance. A preferred apparatus uses a high surface area packing is selected from the group consisting of spherical, snowflake, or pall ring. The apparatus may include the step of using a high surface area packing constructed from a material selected from the group consisting of glass, ceramic, metal, plastic, or glass impregnated plastic. In a preferred apparatus the high surface packing is constructed from a plastic material selected from the group consisting of, polyethylene, polypropylene, or perfluoropolyethylene. In another preferred apparatus includes the step of utilizing a high surface random packing having the properties of high surface area allowing the packed bed depth to be reduced, thereby allowing the distribution system height to be lowered, thus reducing the circulating water pumping head and horsepower. A preferred apparatus employs a high surface area random packing having a surface area in the range of 400 square meters/cubic meter to 3000 square meters/cubic meter. An especially preferred apparatus uses a high surface random packing having a surface area in the range of 400 square meters/cubic meter to 1500 square meters/cubic meter.

Alternatively the invention provides a method for retrofitting a cooling apparatus comprising replacing an existing conventional fill with a high surface area packing for reducing the approach temperature to less than 5 degrees F. Preferably the method provides a high surface area packing having a surface area in the range of 400 square meters/cubic meter to 3000 square meters/cubic meter

### DETAILD DESCRIPTION OF THE INVENTION

Random packing manufactured from various materials selected for suitability with local water conditions is used as “fill” in the water cooling process. The process is utilized in standard cooling towers to replace the “fill” in order to obtain a closer approach to the wet bulb temperature and therefore increase the efficiency of the cooling system.

Water is pumped through flow distribution heads over the surface of packing in the cooling tower to provide cooling of a heat exchange fluid to absorb heat from a process or apparatus. The water is heated as it flows generally from the top of the cooling tower to be cooled by air contacting the water in a counter-flow or cross-flow method through “fill” and thus cools the water through evaporation. By replacing the standard “fill” with the proposed high surface area random packing, the approach to wet bulb is minimized and the cooling tower and system efficiency is increased.

As used herein a high surface area packing is any material having a surface area equal to or greater than 400 square meters per cubic meter. The high surface area packing material may be any material that is inert to prolonged soaking with water and has a surface area in bulk form in excess of 400 square meters per cubic meter, preferably in the range of 400 to 3,000 square meters per cubic meter and most preferably in the range of 400 to 1500 square meters per cubic meter. Preferred materials provide low back pressures when a gas such as air is passed through the wet packing material. An especially effective packing material comprises hollow spheres with passages in the body, shaped like the well known whiffle ball child's toy. Other useful packings include snowflake shapes, star shapes, and the like wherein the material can randomly pack while leaving a sufficient mean free path through the material to keep the air flow adequate for cooling.

### EXAMPLE 1

In a model of the system, done as described below, a significant improvement over prior art cooling was achieved. When water loading greater than 0.163 cubic meters/min./square meter is applied to a cooling tower high surface area packing a wet bulb approach of less than 3° F. is obtained. The air flow through the tower is a function of the geometry of the packing material. The preferred geometry is spherical and the most preferred is a hollow sphere with openings between interior and exterior surfaces.

1. A method for cooling a water stream in an evaporative cooling tower that comprises passing the water stream thru a flow distribution means over a high surface area packing material to wet the surface of the packing material and contacting the wet packing material surface with a moving gas stream.

2. The method of claim 1 utilizing a high surface area packing having the properties of high surface area while also offering low air pressure drop resistance.

3. The method of claim 1 wherein the high surface area packing is selected from the group consisting of spherical, snowflake, or pall ring.

4. The method of claim 1 wherein the high surface area packing is constructed from a material selected from the group consisting of glass, ceramic, metal, plastic, or glass impregnated plastic.

5. The method of claim 1 wherein the high surface packing is constructed from a plastic material selected from the group consisting of, polyethylene, polypropylene, or perfluoropolyethylene.

6. The method of claim 1 utilizing a high surface area packing having the properties of high surface area allowing the packed bed depth to be reduced, thereby allowing the distribution system height to be lowered, thus reducing the circulating water pumping head and horsepower.

7. The method of claim 1 utilizing a high surface area packing having a surface area in the range of 400 square meters/cubic meter to 3000 square meters/cubic meter.

8. The method of claim 1 utilizing a high surface area packing having a surface area in the range of 400 square meters/cubic meter to 1500 square meters/cubic meter.

9. The method of claim 1 wherein the high surface area packing material comprises hollow spheres with passages in the body.

10. 10. An apparatus for cooling a water stream comprising an evaporative cooling tower that comprises a pumping means for delivering a cooling water stream thru a flow distribution means to deliver water flow over a high surface area packing material such that the flowing water wets the surface of the high surface area packing material and means for contacting the wet packing material surface with a moving air stream.

11. The apparatus of claim 10 utilizing a high surface area packing having the properties of high surface area while also offering low air pressure drop resistance.

12. The apparatus of claim 10 wherein the high surface area packing is selected from the group consisting of spherical, snowflake, or pall ring.

13. The apparatus of claim 10 wherein the high surface area packing is constructed from a material selected from the group consisting of glass, ceramic, metal, plastic, or glass impregnated plastic.

14. The apparatus of claim 10 wherein the high surface packing is constructed from a plastic material selected from the group consisting of, polyethylene, polypropylene, or perfluoropolyethylene.

15. The apparatus of claim 10 utilizing a high surface area packing having the properties of high surface area allowing the packed bed depth to be reduced, thereby allowing the distribution system height to be lowered, thus reducing the circulating water pumping head and horsepower.

16. The apparatus of claim 10 utilizing a high surface area packing having a surface area in the range of 400 square meters/cubic meter to 3000 square meters/cubic meter.

17. The apparatus of claim 10 utilizing a high surface area packing having a surface area in the range of 400 square meters/cubic meter to 1500 square meters/cubic meter.

18. The apparatus of claim 10 wherein the high surface area packing material comprises hollow spheres with passages in the body.

19. A method for retrofitting a cooling apparatus comprising replacing an existing conventional fill with a high surface area packing for reducing the approach temperature to less than 5 degrees F.

20. The method of claim 19 utilizing a high surface area packing having a surface area in the range of 400 square meters/cubic meter to 3000 square meters/cubic meter.
